(19) United States
(12) Patent Application Publication
(10) Pub. No.: US 2002/0099890 A1
(43) Pub. Date: Jul. 25, 2002

(54) Apparatus and method for processing interruptions in a data transmission over a bus

(75) Inventors: Xavier Mariaud, Aix-En-Provence (FR); Daniel Klingelschmidt, Aix-En-Provence (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.A., Montrouge (FR)

(21) Appl. No.: 09/989,317

(22) Filed: Nov. 20, 2001

(30) Foreign Application Priority Data
Nov. 21, 2000 (FR) 00 15011

(51) Int. Cl. G06F 13/00

(52) U.S. Cl. 710/110; 710/260

(57) ABSTRACT

A circuit is provided for reducing losses of the start of a new message caused by the microcontroller of a slave apparatus being unavailable. The circuit generates an interruption signal when the slave apparatus has received and acknowledged a start of a new message but the microcontroller is unavailable because it is processing a preceding message or an application of the slave apparatus.

### FIELD OF THE INVENTION

The invention relates to the field of binary data transmissions in serial form along a cable, and, more particularly, to an apparatus and method for processing interruptions of a microcontroller during the transmissions and supervising the transmission operations.

### BACKGROUND OF THE INVENTION

A bilateral transmission of binary information between an apparatus A (FIG. 1), typically referred to as a “host” or “master,” and an apparatus B, typically referred to as a “peripheral” or “slave,” can be carried out in different ways. One such way is via a cable 20 having four conductors. For example, a first conductor may provide a supply voltage, second and third conductors may provide the binary signals, and a fourth conductor may be connected to a reference voltage (e.g., ground).

The binary signals sent by the second and third conductors are grouped in the form of messages whose formats are set by standards or protocols. One of these protocols is the universal serial bus (USB) protocol, in which transmissions or transfers can be of different types. One of these types, known as transfer command, includes three transactions or stages. A first one of the stages is a start phase 10 (FIG. 3) during which the master apparatus A sends to the slave apparatus B a message to which the receiver 24 of the slave apparatus responds with an acknowledge signal ACK (FIG. 3) when it correctly receives the message. The message includes a first part SETUP indicating, for example, the start of a read command, and a second part DATA including data and indicating the type of command.

Another of the stages is a data transfer stage 12 during which the master apparatus A sends a message IN signaling that it is awaiting reception of the data read following the command. Not being available (ready), the microcontroller 24 of the slave apparatus sends a message NAK signaling a non-acceptance. At a later stage, the master apparatus A resends the message IN, to which the slave apparatus then responds by sending the read data DATA. The master apparatus then returns an acknowledgement of receipt ACK.

The third stage is a state phase 14 during which the MASTER apparatus sends a message OUT which is not followed by data, indicating the end of transfer. The microcontroller not being available (ready), the slave apparatus sends a message NAK signaling a non-acceptance. At a later stage, the master apparatus resends the message OUT without data, in which case the slave apparatus responds by an acknowledgement of receipt ACK. The slave apparatus is then in possession of the entire message, which can then be processed by the microcontroller.

It will be appreciated that during the different transfer phases 10, 12 and 14, there are provisions which allow the master apparatus to repeat its part of the message IN and OUT while the microcontroller is unavailable. If the phase that follows is a start phase and the microcontroller is unavailable, the slave apparatus returns no signal (no NAK, nor STALL, nor ACK signal), which is interpreted by the master apparatus as a transmission error. In such case the master apparatus resends the message.

Such an operation only appears if the time period during which the microcontroller is unavailable exceeds a time interval separating two consecutive messages. However, in high speed data transfers, these time intervals between two messages are increasingly short. Yet, the microcontroller of the slave apparatus has to perform more and more tasks, whereupon the time periods during which it is unavailable are longer and longer.

At the end of transfer phases 10 or 12, an interruption of the microcontroller to process the part of the transmitted message may be requested. To this end, a flag CTR is set to the logic 1 state to indicate that an interruption is requested (FIG. 3(d)). After a certain time (which depends on the application), the interruption requested by the USB bus is processed. At the end of the interruption, the program executed by the microcontroller returns the flag CTR to the logic 0 state, thus authorizing the transfer of the following part of the message. A software state machine then processes the information concerning the event of the USB message extracted by the interruption routine.

As a result of the above operations, no transfer over the USB bus is authorized when the flag is in the logic 1 state. There is, therefore, a dependency between the time for processing an interruption and the time delay in accepting the following transfer, the time for processing the interruption being linked to microcontroller's operating frequency. Further, the time delay between each transaction depends on the master apparatus in that if that time delay is shorter than the minimum time for processing an interruption by the microcontroller, the following transfer cannot be authorized. This can result in the failure of the transaction.

### SUMMARY OF THE INVENTION

An object of the present invention is to provide a device and related method for a slave apparatus controlled by a microcontroller which allows, at the end of a message, an acceptance of the start of the following message while the microcontroller is unavailable. That is, the device and method address the problem of receiving the first part of a new message while the microprocessor is not available.

The invention relates to a device for processing interruptions in a slave apparatus B (e.g., a computer peripheral) which is connected to a master apparatus A (e.g., a computer) via a cable having several conductors to enable an exchange of binary information between the two apparatuses according to the USB protocol. The slave apparatus may include a sending/receiving circuit for binary information received and sent over the cable which supplies signals, control circuitry or means for controlling state latches receiving the signals of the sending/receiving circuit and supplying state signals of the sending/receiving circuit, and a microcontroller for processing applications of the slave apparatus and, notably, the binary information received and sent over the cable via the sending/receiving circuit. More particularly, the interruption processing device may include a control circuit for controlling an interruption state latch to supply an interruption signal when the sending/receiving circuit has received the start of a new message, the start of message being acknowledged and recorded by the sending/receiving circuit.

A method aspect of the invention is for processing interruptions in a slave apparatus (e.g., a computer peripheral) which is connected to a master apparatus (e.g., a computer) by a cable having several conductors capable of operating according to the USB protocol. The method may include (a) producing a state signal indicating the end of a message, (b) detecting the start of a new message coming from the master apparatus and producing a start of message state signal, (c) recording the data in the start of message, (d) acknowledging receipt of the start of message, (e) producing a signal indicating the end of step (c), and (f) producing an interruption signal in the presence of signals signaling an end of a preceding message, a start of a new message, and the end of step (e).

### BRIEF DESCRIPTION OF THE DRAWINGS

Other characteristics and advantages of the present invention will become more apparent from the following description of a preferred embodiment, given with reference to the appended drawings, in which:

FIG. 1 is a schematic block diagram showing two apparatuses connected by a USB type cable;

FIG. 2 is a schematic diagram showing the electronic circuits used to implement the invention;

FIGS. 3(a) to 3(k) are timing diagrams showing the sequence of operations for implementing the invention;

FIG. 4 is a schematic block diagram of a state machine for implementing the USB protocol;

FIG. 5 is a flow diagram showing the different phases in a routine for processing USB interruptions; and

FIG. 6 is a flow diagram showing the steps of a main loop of the USB program run by the microcontroller.

### DETAILED DESCRIPTION OF THE PREFERRED EMBODIMENTS

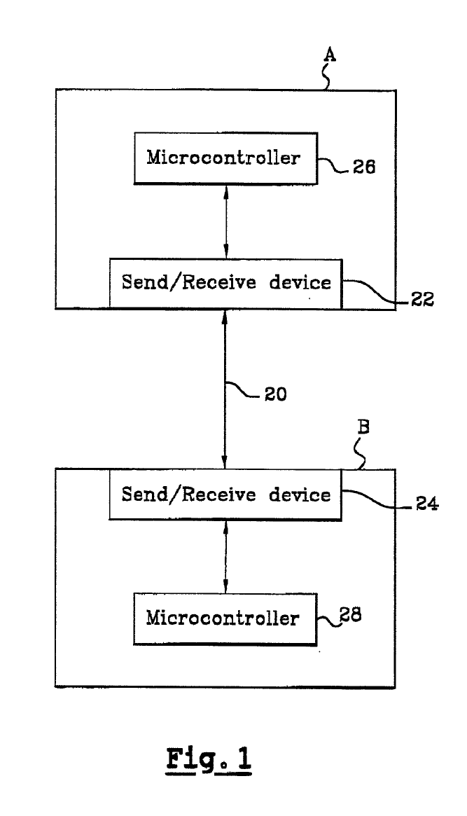

Turning now to FIG. 1, a master apparatus A is connected to a slave apparatus B via a four-conductor cable 20. In each apparatus A and B, the cable is connected to a respective sending/receiving device 22 and 24 which sends and receives electrical signals in serial, binary form sent to/received from the other apparatus. At the output of the sending/receiving device 22 or 24, the binary information to be sent is available in parallel form for processing by a respective microcontroller or microprocessor 26 or 28.

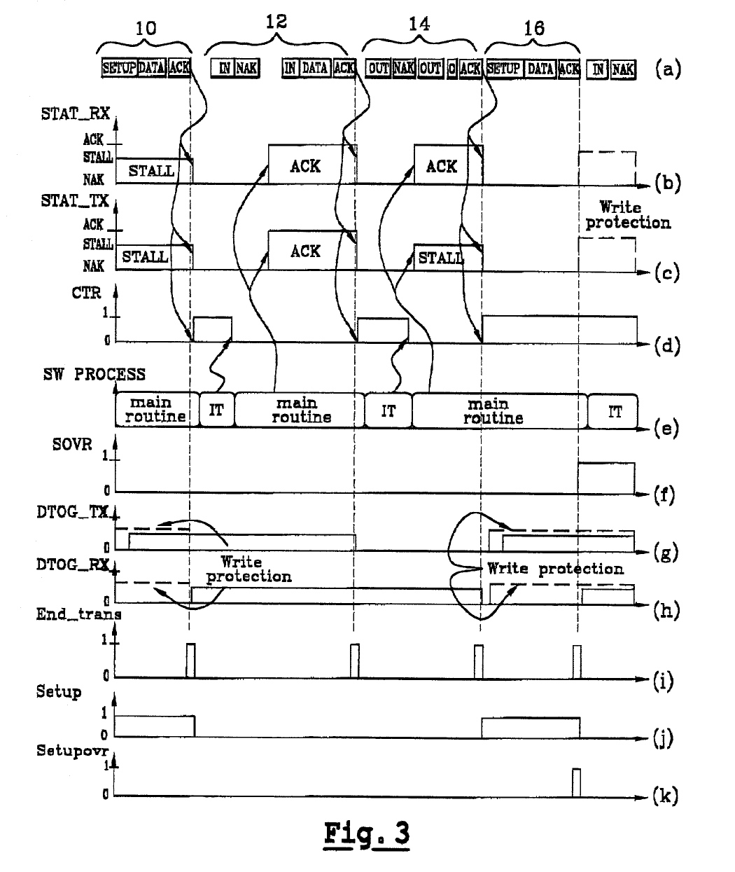

The device and method according to the invention relates particularly to the slave apparatus B and, more particularly, the processing of the arrival of a new binary information message while the microcontroller 28 is not available for processing the latter. As noted above, the first part 16 (FIG. 3) of the following message is lost in existing prior art systems. An existing system provides for the master apparatus to repeat this start of message, but the latter can be effectively recorded only when the microcontroller is available again. This is, it responds positively to the request of the master apparatus, resulting in a considerable loss of time.

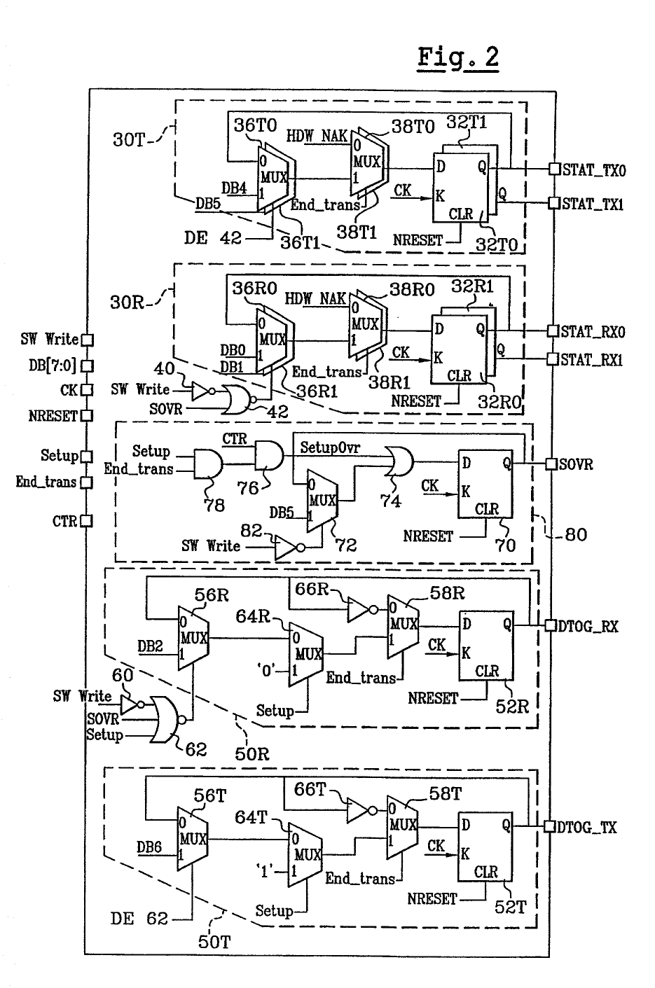

In an existing system, the device includes (FIG. 2) the circuits within boxes 30R, 30T, 50R and 50T, which are shown with dashed lines. Each box 30R or 30T includes two D-type state latches 32R0, 32R1 or 32T0, 32T1 which define four states in accordance with table I.

TABLE I

| LATCHES | LATCHES | |
|---|---|---|
| 32R1 | 32R0 | |
| 32T1 | 32T0 | MEANING |
| 0 | 0 | DISABLED: The |
| | | peripheral can no |
| | | longer carry out a |
| | | function and the |
| | | received messages are |
| | | ignored. |
| 0 | 1 | STALL: The peripheral |
| | | is off or does not |
| | | support the type of |
| | | request received and |
| | | all requests result |
| | | in a STALL response. |
| 1 | 0 | NAK: All requests |
| | | result in a non- |
| | | acceptance message |
| | | NAK because the |
| | | peripheral is not |
| | | ready. |
| 1 | 1 | VALID: The peripheral |
| | | is ready to receive a |
| | | transaction. |

These latches change state as a function of the signal applied to the D input terminal, but specifically at the time a clock pulse CK is applied to the K input terminal. They are reset to the logic 0 state by an signal NRESET at the CLR input terminal.

The signals applied to the D input terminal of a latch 32R0/32R1 (or 32T0/32T1) come from a bus DB of the microcontroller 28 via two multiplexers, of which one 36R0/36R1 (or 36T0/36T1) is controlled by a signal SW Write supplied by the program of the microcontroller. The other 38R0/38R1 (or 38T0/38T1) is controlled by a signal End_trans supplied by the peripheral's sending/receiving device 24. The output terminal of multiplexer 36R0/36R1 (or 36T0/36T1) is connected to an input terminal of the multiplexer 38R0/38R1 (or 38T0/38T1), the other input terminal of which receives a signal HDW NAK from the sending/receiving device.

In current practice, the signal SW Write is applied to the multiplexer 36R0/36R1 (or 36T0/36T1) via just an inverter 40. The bus DB includes eight conductors numbered DB0, DB1, . . . , DB7, where conductors DB0, DB1, DB4 and DB5 are connected respectively to the “1” input terminals of the multiplexers 36R0, 36R1, 36T0 and 36T1. In accordance with the invention, the circuit is modified to apply the signal SW Write via the inverter circuit 40 and an inverting OR gate 42, whose other input terminal receives a signal SOVR supplied by the output terminal Q of a D-type latch 70 of a circuit 80.

Each box 50R (or SOT) according to the prior art includes a D-type latch 52R (or 52T). These latches 52R and 52T indicate the one of the two types of data tokens DATA 1 or DATA 0 that are received or sent. More particularly, DATA 1 is expected when DTOG_RX or DTOG_TX is in the logic 1 state, and DATA 0 is expected when DTOG_RX or DTOG_TX is in the 0 state. Further, the sequence of data should appear in an order such that DATA 1 alternates with DATA 0, thus allowing a check on the data and a resynchronization.

The signals for controlling latches 52R (or 52T) at the D input terminals come from bus DB of the microcontroller via three multiplexers 56R, 64R and 58R (or 56T, 64T, and 58T). One 56R (or 56T) is controlled by the signal SW Write, another 64R (or 64T) is controlled by a signal Setup, and the third 58R (or 58T) is controlled by the signal End_trans. The latch 52R (or 52T) is held in its state by the return on an input of multiplexers 56R (or 56T) and 58R (or 58T), directly for multiplexer 56R (or 56T), or via an inverter circuit 66R (or 66T) for the multiplexer 58R (or 58T).

Conductors DB2 and DB6 of bus DB are respectively connected to the 1 input terminals of multiplexers 56R and 56T. The output terminal of multiplexer 56R (or 56T) is connected to an input terminal of the multiplexer 64R (or 64T) whose other input terminal receives from the microcontroller a logic 1 state signal for the latch 52T when sending and a logic 0 state signal for the latch 52R when receiving. The latch 52T is assigned to sending, while the latch 52R is assigned to receiving.

In the prior art, the signal SW Write is applied, via the inverter circuit 60, to the multiplexer 56R (or 56T). According to the invention, this signal passes via an inverting OR gate 62 which has two other input terminals, i.e., one for receiving the signal SOVR supplied by the latch 70 of the circuit 80, and another for receiving the signal Setup.

The circuit 80 includes, in addition to the D-type latch 70, a multiplexer 72 having one input terminal connected to the conductor DB5 of the microcontroller bus DB and the another input terminal connected to the Q output of the latch 70 to maintain it in its state. The multiplexer 72 is controlled by the SW Write signal via an inverter circuit 82.

The output terminal of the multiplexer 72 is connected to one of the two input terminals of an OR gate 74 whose output terminal is connected to the D input of the latch 70. The other input terminal of the OR gate 74 is connected to the output terminal of a two-input AND gate 76, of which one input receives a signal CTR and the other is connected to the output terminal of a two-input AND gate 78. One input of the AND gate 78 receives the signal End_trans, and the other input receives the signal Setup.

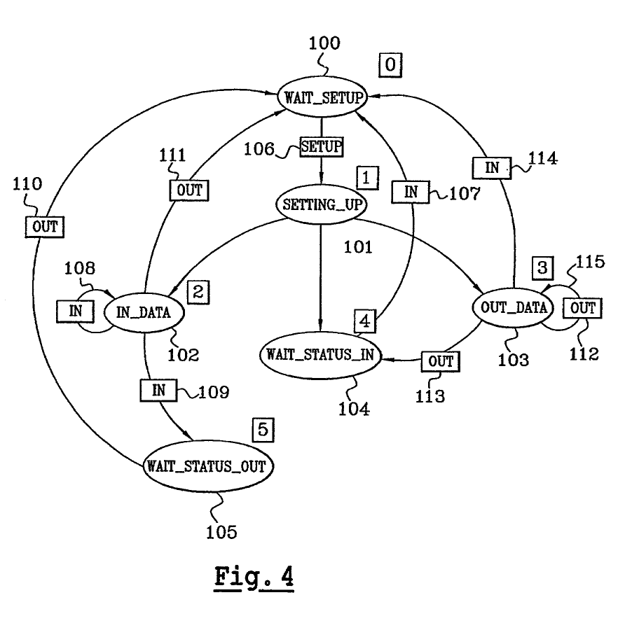

The processing of messages exchanged between the master apparatus A and the slave apparatus B is performed by a state machine, which will now be described with reference to the flow chart of FIG. 4. The machine has six states, namely 100 for STATE 0, 101 for STATE 1, 102 for STATE 2, 103 for STATE 3, 104 for STATE 4, and 105 for STATE 5. The state STATE 0 is a wait state for awaiting a command starting with a SETUP token (10 in FIG. 3(a)), also referred to as WAIT-SETUP in FIG. 4.

The machine passes to STATE 1, referred to as SETTING_UP, when it detects the token SETUP (Block 106). During STATE 1, the machine processes the data received with the token SETUP. Three cases may result, namely: (a) a phase of data transfer from the peripheral B to the master apparatus A corresponding to STATE 2, also referred to as IN_DATA; (b) a phase of data transfer from the master apparatus A to the peripheral B corresponding to STATE 3, referred to as OUT-DATA; and (c) an end of command, corresponding to STATE 4, also referred to as WAIT_STATUS_IN, which is a wait period for receiving an IN token (Block 104) followed by no data, which concludes the transfer phase of the master apparatus A to the peripheral B.

During the IN_DATA STATE 2, the peripheral sends all the data packets IN to the master apparatus A (loop 108). At the last packet IN, the state machine passes to a WAIT_STATUS_OUT STATE 5 to await a token OUT (illustrated with reference numeral 14 in FIG. 3(a)). Upon receiving the token OUT (Block 110), the state machine returns to STATE 0 to await a SETUP token 106. When the token OUT is detected in STATE 2 (Block 111), the state machine returns to STATE 0, since this results from an error on the master apparatus side.

During OUT_DATA STATE 3, the peripheral receives data packets OUT coming from the master apparatus (loop 115). At the last packet OUT (Block 113), the state machine passes to a WAIT_STATUS_IN STATE 4, which allows for the return to STATE 0 as indicated above. The state machine returns directly from STATE 3 to STATE 0 upon receiving a token IN (Block 114) which corresponds to an error of the master apparatus.

The invention provides for relatively fast processing of transitions of state between STATE 4, STATE 0 and STATE 1 on the one hand, and STATE 5, STATE 0 and STATE 1 on the other. The second case, in which a token OUT corresponding to a STATE 5 to STATE 0 transition is followed by the receipt of a token SETUP corresponding to a STATE 0 to STATE 1 transition, is illustrated in FIG. 3. This occurs without the program having time to carry out the processing of the STATE 5 to STATE 0 transaction.

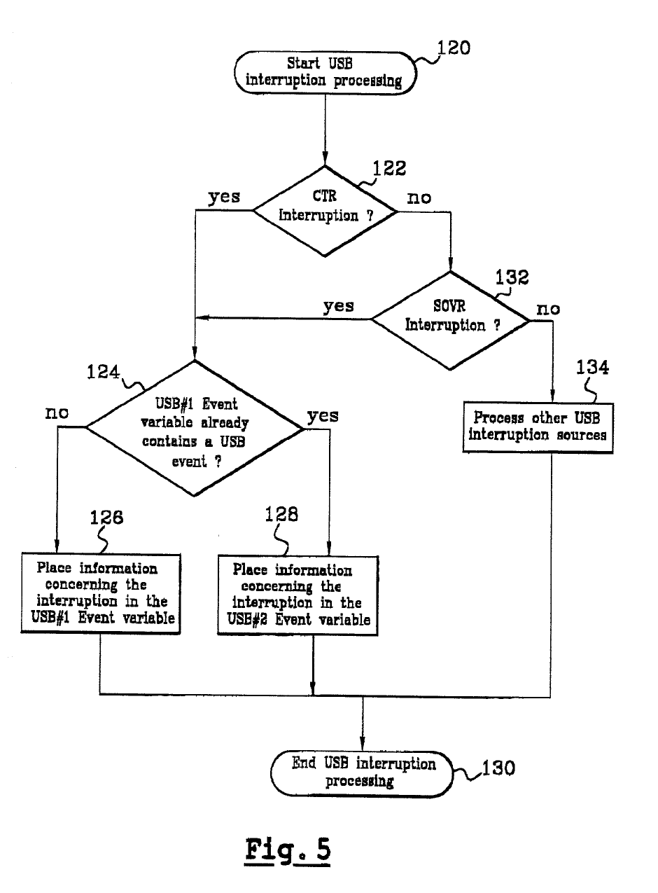

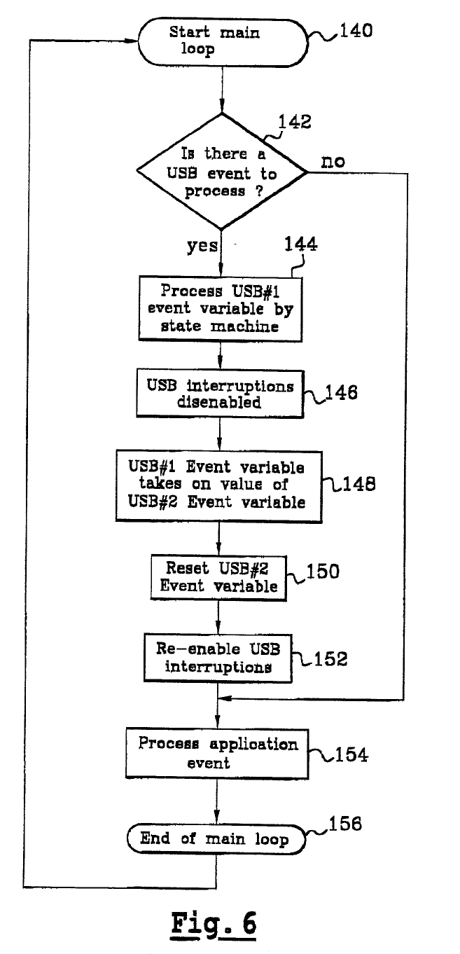

By virtue of the invention, the first STATE 5 to STATE 0 transition generates a interruption CTR of the microcontroller, while the second STATE 0 to STATE 1 transition generates an interruption SOVR. These interruptions are processed sequentially by a program according to the flow chart of FIG. 5. However, the information concerning the interruption type CTR or SOVR is first stored in a variable designated USB#1 Event. If this variable already includes information concerning a previous USB event, the new information is stored in a second USB#2 Event variable. The USB#l and USB#2 Event variables are managed by the main loop of the program according to the flow chart of FIG. 6.

The USB interruption processing routine includes a step 120 of starting USB interruption processing, and a step 122 of detecting the type of CTR interruption for the peripheral considered. If a positive response is provided, a step 124 of determining if the USB#1 Event variable already contains an USB event is performed. If a negative response is provided, a step 126 is performed to place the information concerning the interruption in the USB#l Event variable. The routine then terminates by an end of USB interruption processing at step 130.

In the case where the response is positive, at step 124 (i.e., the USB#1 Event variable already includes an USB event), the loop passes to a step 128 to place information concerning the interruption in the USB#2 Event variable. The routine then terminates with the end of USB interruption processing step 130. Further, in the case where the response is negative at step 122 (i.e., the interruption is not of the CTR type for the peripheral concerned), the routine then passes to step 132. The step 132 enables a determination of whether or not the routine is dealing with an interruption SOVR generated by the peripheral concerned. In the case of a positive response, the loop passes to step 124 described above to determine if the USB#1 Event variable already includes a USB#1 event.

A negative response at step 132 signifies that there is no interruption SOVR to process, and the routine passes to a step 134 of processing other sources of USB interruption. When the other sources of interruption are processed, the loop passes to the end of USB interruption processing step 130.

To manage both the USB#1 and USB#2 Event variables, the main loop carries out the following operations or steps 140 to 156 (FIG. 6). The main loop begins with a main loop starting step 140 and passes onto the following step 142 to determine whether there is a USB Event to process. In the case of a negative response, the loop passes to a step 154 of processing the event corresponding to the current application in the peripheral and then, at the end of such processing, to an End of Main loop step 156 which enables a return to the starting step 140. In the case of a positive response at step 142, the loop passes to step 144 of processing the USB#1 Event variable by the state machine of FIG. 4.

At the end of processing the USB#1 Event variable, the loop passes to a step 146 during which the USB interruptions are not validated, e.g., by masking the interruption register. At a step 148, which follows step 146, USB#1 Event variable takes on the value of USB#2 Event variable. The USB#2 Event variable is reset by a step 150 which is followed by a step 152 of re-enabling USB interruptions.

The operation of the device and method according to the invention will now be described for the case where the master apparatus A orders a readout of data in the slave apparatus B and the transfer of read data to the master apparatus A. Upon detection of a token SETUP (designated with reference numeral 10 in FIG. 3(a)), the signal Setup passes to logic 1 (FIG. 3(j)) and remains in that state up to the end of the period 10, i.e., up to the appearance of the End_trans signal which indicates the sending of the acknowledgement ACK.

During this period of the signal Setup in logic state 1, the states of latches 32R0/32R1 and 32T0/32T1 are such that their decoding corresponds to the STALL (see Table I, above), which forbids all transmission requests. During this logic 1 state period of the signal Setup, latches 52R and 52T (DTOG_RX and DTOG_TX) are write protected by virtue of the state signal Setup applied to the input terminal of the inverting OR gate 62 (FIG. 2). Also, latch DTOG_TX is switched over from the logic 0 state to the logic 1 state to indicate that the data to be sent (IN) is of the DATA 1 type.

At the end of signal End trans, which signals the sending of the acknowledge signal ACK, the state signal CTR=1 passes to a logic 1 state to indicate the event to the microcontroller. The latter passes from the main routine to the interrupt routine to execute steps 120, 122, 124, 126 and 130 (FIG. 5) and then returns to the main routine at the end of the state signal CTR=1.

During this main loop, the microcontroller processes the USB#1 Event variable by the state machine, i.e., the sending (IN) of the type DATA 1 data as DTOG_TX=1 by the slave apparatus. On the other hand, DTOG_RX passes from a logic 0 state to a logic 1 state at the signal End_trans to indicate that the data being received (OUT) is of the DATA 1 type. When the master apparatus sends the signal ACK at the end of the period 12, the signal End_trans causes the CTR state signal to pass from logic 0 to 1, making the microcontroller unavailable for receiving the OUT command. Thus, the Slave apparatus returns a non-acceptance signal NAK.

Over the duration of the CTR=1 state, the microcontroller executes the interrupt loop 120, 122, 124, 126 and 130 so that upon returning to the main loop the state machine performs the processing for receiving the DATA 1 type OUT data. During this main loop, latches 32T0 and 32T1 are set to the STALL state for sending, while latches 32R0 and 32R1 are set to the ACK state, i.e., they can receive the OUT data.

As soon as the acknowledge signal ACK has been sent by the slave apparatus, a new signal End_trans is generated and the CTR state signal passes to the logic 1 state, which gives notice to the microcontroller. The microcontroller continues to run in another interrupt routine, delaying the processing of the CTR interrupt. If the master apparatus then sends a command SETUP, the signal Setup passes to the logic 1 state (FIG. 3(j)) which write protects latches DTOG_TX and DTOG_RX (FIGS. 3(g) and 3(h)). However, before this write protection by software, the signal End_trans causes DTOG_RX to pass to the logic 0 state (FIG. 2), indicating that the data being received is of the DATO 0 type.

Yet, this write protection of DTOG_TX and DTOG_RX by software does not prevent a change of state via circuits of the peripheral and, more particularly, by multiplexers 64R and 64T controlled by the signal Setup and which receives as input signals logic 1 for latch 52T and logic 0 for latch 52R. When the token SETUP is detected, the sending/receiving device of the slave apparatus receives the contents DATA and records them in place of the data OUT, which has no consequence since the token OUT is not followed by any data.

As soon as the contents DATA of SETUP have been received, the sending/receiving device sends an acknowledgement signal ACK and generates a signal End_trans. The simultaneous presence of signals Setup=1, End_trans=1 and CTR=1 produces a signal Setupovr (see reference numerals 76, 78 in FIG. 2), which sets the latch 70 to a logic 1 state, giving rise to a SOVR=1 l signal (FIG. 3(f)). As soon as the SOVR=1 signal appears, an interruption routine is launched including steps 120, 122, 132, 124, 128 and 130 (FIG. 5).

The above description defines a method of processing interruptions in a slave apparatus B, such as a computer peripheral, connected to a master apparatus A, such as a computer, via a multi-conductor cable capable for operating according to the USB protocol. The method includes the steps of: (a) producing a state signal CTR indicating the end of a message; (b) detecting the start 16 of a new message coming from the master apparatus and producing a start of message state signal Setup; (c) recording the data in that start of message; (d) acknowledging receipt ACK of that start of message; (e) producing a signal End_trans indicating the end of the previous step (c); and (f) producing an interruption signal SOVR in the presence of signals signaling the end of a message preceding CTR, the start (Setup) of a new message, and the end of step (e) End_trans.

That which is claimed is:

1. Device for processing interruptions in a Slave apparatus (B) such as a computer peripheral which is connected to a Master apparatus (A) such as a computer via a cable (20) having several conductors to enable an exchange of binary information between the two apparatuses according to the USB protocol, said Slave apparatus comprising:
a sending/receiving circuit (24) for binary information received and sent over the cable (20), which supplies signals (Setup, CTR, End_trans),
control circuit means (30R, 30T, 50R, 50T) for controlling state latches (32R0/32R1, 32T0/32T1, 52R, 52T) receiving the signals (Setup, CTR, End_trans) of the sending/receiving circuit (24) and supplying state signals of the sending/receiving circuit, and
a microcontroller (28) for processing applications of the Slave apparatus and, notably, the binary information received and sent over the cable (20), via the sending/receiving circuit, characterized in that said interruption processing device comprises a control circuit (80) for controlling an interruption state latch (70) such as to supply an interruption signal (SOVR) when the sending/receiving circuit (24) has received the start (SETUP) of a new message, said start of message having been acknowledged (ACK) and recorded by said sending/receiving circuit.

2. Device according to claim 1, characterized in that said control circuit for controlling the interruption state latch (70) comprises logic circuits (74, 76 and 78) which, receiving the signals (Setup, End_trans, CTR) of the sending/receiving circuit (24), supply a signal (Setupovr) which sets the interruption state latch to a “1” state to indicate a microprocessor interruption request.

3. Device according to claim 1 or 2, characterized in that the control circuit means for controlling the state latches (32R, 32T, 52R and 52T) further comprise means (42, 62) for preventing writing into the state latches (32R0/32R1, 32T0/32T1, 52R and 52T) by the microprocessor (28) during the receipt of a start of message (Setup) and the presence of the interruption signal (SOVR).

4. Method of processing interruptions in a Slave apparatus (B), such as a computer peripheral, which is connected to a Master apparatus (A), such as a computer, by a cable having several conductors capable of operating according to the so-called “USB” protocol, characterized in that it comprises the steps of:
(a) producing a state signal (CTR) indicating the end of a message,
(b) detecting the start (16) of a new message coming from the Master apparatus and producing a start of message state signal (Setup),
(c) recording the data contained in said start of message,
(d) acknowledging receipt (ACK) of said start of message,
(e) producing a signal (End_trans) indicating the end of the previous step (c), and
(f) producing an interruption signal (SOVR) in the presence of signals signaling an end of preceding message (CTR), a start (Setup) of a new message and the end of step (e) (End_trans).
